(19) United States
(12) Patent Application Publication
(10) Pub. No.: US 2014/0296121 A1
(43) Pub. Date: Oct. 2, 2014

(54) STABLE AQUEOUS PAP SUSPENSION

(71) Applicant: RECKITT BENCKISER N.V., WT Hoofddorp (NL)

(72) Inventors: Alias Al-Bayati, Ludwigshafen (DE); Yun Chen, Ludwigshafen (DE); Andreas Hofsäss, Ludwigshafen (DE); Gerhard Kämmerer, Ludwigshafen (DE)

(73) Assignee: RECKITT BENCKISER N.V., WT Hoofddorp (NL)

(21) Appl. No.: 14/353,403

(22) PCT Filed: Oct. 26, 2012
(86) PCT No.: PCT/GB2012/052662

§ 371 Date: Apr. 22, 2014

(30) Foreign Application Priority Data
Oct. 31, 2011 (GB) 1118763.0

(51) Int. Cl. C11D 3/28

(52) U.S. Cl. CPC C11D 3/28
USPC 510/221

(57) ABSTRACT

A storage stable aqueous suspension of PAP is provided.

Liquid and gel automatic washing detergent compositions enjoy great popularity with consumers. This is due to actual positive product properties such as improved solubility and perceived positive properties such as gentleness and reduced propensity to leave marks on cleaned articles.

In particular mono-dose liquid or gel compositions are popular as they offer these benefits as well as efficient dosing and often attractive aesthetics. Mono-dose gel and liquid formulations are often contained within translucent soluble plastic films, commonly polyvinyl alcohol (PVOH) films.

Complications arise however from the use of liquid and gel formulations. Primarily these come from the incorporation of the various sensitive ingredients found in detergent compositions into a liquid or gel environment. The liquid or gel environment offers increased potential for chemical reactions to occur in comparison with a solid environment.

Bleaching agents are examples of sensitive ingredients that are commonly found in automatic machine detergent compositions. For instance perborates or percarbonates, which are often used in solid washing agent formulations, are moisture sensitive. The result of this that they lose their bleaching power within a few days in a liquid (and particularly aqueous) washing or cleaning agents, due to the loss of active oxygen.

Percarboxylic acids, especially imidopercarboxylic acids, the most important representative of which is phthalimidopercaproic acid (PAP), are more efficient and less sensitive to hydrolysis and are known in the prior art as bleaching agents for washing and cleaning agents.

Nevertheless, despite their improved performance, imidopercarboxylic acid storage stability is still far from sufficient to for use in liquid washing formulations without steady loss in activity. The addition of percarboxylic acids, particularly imidopercarboxylic acids, in liquid or gel washing and cleaning agents is therefore still problematic.

Another difficulty with using peroxy acids such as PAP in conjunction with the PVOH films/extrusions used in monodose products is that the peroxy acids additionally can react with the PVOH. This causes a loss in bleaching performance and either the weakening or complete destruction of a portion of the PVOH.

Because of these disadvantages attempts have been made in the prior art to modify the PAP, such that the imidopercarboxylic acid in these formulations has a greater stability.

One method identified to stabilize these percarboxylic acids is through putting a protective outer shell layer onto the percarboxylic acids in order to prevent any direct contact with the aqueous dispersion. However, the layered shell systems, known from the prior art, are often not sufficiently compatible with the dispersion medium and in any case do not always provide the right balance between stability and release time into the wash.

For example, certain shell materials can be dissolved over time by the dispersion medium. Other shell layer materials, particularly waxes having high melting points, (see EP 0 510 761 B1 and U.S. Pat. No. 5,230,822) have the disadvantage that they only release the enveloped or encapsulated percarboxylic acids at relatively high temperatures and in addition leave insoluble residues behind.

Other attempts have been made to adjust the properties of the dispersion medium to give more stability to the percarboxylic acids. The measures known from the prior art, however, are not particularly effective, or generally applicable.

Thus, EP 0 334 405 B1 describes aqueous bleaching agent compositions containing solid, particulate, essentially water-insoluble, organic percarboxylic acids, wherein 1 to 30 wt. % of a secondary C₈-C₂₂ alkane sulfonate and 0.5 to 10 wt. % of a fatty acid are added to stabilize the percarboxylic acid against phase separation from the aqueous liquid. However, the resulting stabilizing effect is not always adequate.

In a similar way, it was also attempted in EP 0334404 B1 to stabilize the percarboxylic acid against phase separation from the aqueous liquid. However, the percarboxylic acids could not be sufficiently stabilized against decomposition.

Overall, no efficient measures are disclosed in the prior art for an adequate stabilization of percarboxylic acids in aqueous dispersions

It is the object of the present invention to provide a stable aqueous formulation for percarboxylic acids, and more specifically PAP. It is also the object of the present invention to provide such a stable aqueous liquid or gel PAP formulation that is also stable for in storage in PVOH films or capsules (or other containers).

In one aspect of the present invention there is provided an aqueous liquid or gel PAP suspension, comprising solid PAP dispersed in an aqueous sugar compound.

In a further aspect of the present invention there is provided a method of making the aqueous PAP suspensions.

In another aspect of the present invention there is provided an automatic ware washing detergent composition comprising the aqueous PAP suspensions,

To achieve this aim, the applicants have managed to develop aqueous PAP suspensions that are storage stable. The additional surprising result is that the aqueous PAP suspensions are also stable with PVOH, despite the aggressive nature of both water and PAP towards PVOH.

Currently there is an aqueous PAP suspension that is commerically available. Unfortunately this commercial suspension is provided only with very low active levels of PAP however. This commercially available suspension is therefore not effective for use in detergent compositions enveloped in PVOH films or capsules. This is due to both the high water levels contained within the suspension, which quickly degrades the PVOH and the low concentration of active, which makes it inefficient for use in dosing in ware washing machines. (Large volumes are required to provide effective bleaching power.)

The applicants have managed to obtain a stable aquous PAP suspension with high active levels by utilising a concentrated carbohydrate solution as the suspension medium.

Any carbohydrate solution can be used. This includes sugars such saccharides, polysaccharides and glycols and polyglycols. For the purposes of the present invention carbohydrates may also include sugar derivatives such as sugar alcohols, which are hydrogenated sugars.

A particularly preferred carbohydrate is sorbitol. However the invention can be carried out with different sugars.

Other non-limiting examples of carbohydrate compounds that may be used in the present invention are mannitol, xylitol, sucrose, glucose, fructose and mannose. The skilled person will be aware of many more.

The carbohydrate comprises between 40 and 80% by weight of the PAP suspension. Preferably the carbohydrate comprises between 45 and 75% by weight and more preferably between 50 and 70% by weight.

Preferably the solid PAP comprises between 5 and 60% by weight, more preferably 10 and 50% by weight, more preferably 20 and 40% by weight of the PAP suspension.

Solid PAP that is commmercially obtained is usually only between 60-70% pure. The weight remainder of the commercially supplied solid PAP comprising stablizing chemicals.

Unless specifically stated otherwise, weight percentages of PAP that are quoted within this document are for the solid commericial product. The active material comprises 60-70% of this weight.

The solid PAP used to form the suspension may be in the form of granules or powder.

Additional ingredients that may be used to prepare the suspension are thickening agents. An example of a thickening agent is guar gum. Other thickening agents may be used. Non limiting examples of other thickening agents are xantham gum and others such as a poly carboxylate based polymers and PVP.

A preferred thickening agent is xanthan gum.

The thickening agent may be present between 0.01 and 20% by weight of the aqueous suspension, preferably between 0.1 and 10% by weight, more preferably between 0.3 and 5% and most preferably between 0.3 and 1% by weight of the aqueous suspension.

In general, the greater the amount of thickening agent, the more gel-like the aqueous suspension will become.

Water may be present in the PAP suspension in amounts less than 35% by weight. Preferably water is present in amounts less than 25%, more preferably 12% and most preferably less than 10%.

In general, the lower the water levels, the more gel-like the aqueous suspension will become.

Surprisingly the aqueous PAP suspensions of the present invention are both storage and PVOH stable.

This allows for the use of the inventive aqueous PAP suspensions in liquid or gel monodose gelcaps. These are popular detergent compositions for automatic washing machines that comprise a liquid or gel detergent, in an amount suitable for a single wash, encased in a soluble outer film or capsule.

The most common material used as a soluble film or capsule is (poly vinyl alcohol) PVOH.

The PVOH can be used in a film form. A specific example of PVOH film that can be used with the aqueous PAP suspensions of the present invention is PT-90 from Aicello. However the invention is not limited to this particular film. Other grades of PVOH film, both blown and solvent cast can be utilised without issue.

Additionally the PAP suspensions of the present invention can be stored in PVOH resin containers. And such resins may be prepared with both injection moulding and extrusion methods with no problem.

The aqueous PAP suspensions of the present invention may be used to form the whole or a part of automatic ware washing detergent formulations.

Preferably the suspensions may be used to form the whole or part of monodose detergent compositions.

To form the whole of a detergent composition, other ingredients may be added to the suspensions. The other components may contain, for example, enzymes, builders, surfactants, polymers etc.

Or alternatively, and preferably, the PAP suspensions may make up a discrete single sub-component of a multicomponent monodose composition. With other constituent sub-components comprising the other required ingredients. For example in a multichamber PVOH wrapped monodosing composition.

Preferably the PAP suspensions are used to form ADW (automatic dish washing) detergent compositions.

If the PAP suspensions of the present invention are used as part of an automatic ware washing composition, the ware washing composition may comprise one or more of the following ingredients.

Other Bleaches

There may be other bleaching compounds in the detergent compositions as well as the PAP. A combination of bleaching compounds can be used.

Most preferably the other bleaches are selected from inorganic peroxy-compounds and organic peracids and the salts derived therefrom.

Examples of inorganic perhydrates include persulfates such as peroxymonopersulfate (KMPS), perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life.

The preferred percarbonate is sodium percarbonate of the formula 2Na₂CO₃.3H₂O₂. A percarbonate, when present, is preferably used in a coated form to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and, optionally, the salts thereof.

The pH of the detergent composition may be between 6 and 14, preferably between 8 and 12 and more preferably between 9 and 11.

Builders

The detergent composition may further comprise one or more builder compounds. These may be selected, for example, from the group comprising STPP, sodium citrate, sodium iminodisuccinate, sodium hydroxyiminodisuccinate, MGDA, and glutamic diacetic acid sodium salt or combinations thereof. However the detergent compositions are not limited to these builders

Preferably, the total builder quantity in the detergent composition comprises from 5% to 95% by weight, preferably from 15% to 75% by weight, preferably from 25% to 65% by weight, most preferably from 30% to 60% by weight of the detergent composition.

Oxidation Catalysts

The detergent compositions may also include oxidation catalysts.

Some non limiting examples of other oxidation catalysts that may be used in the detergent compositions include manganese oxalate, manganese-acetate, manganese-collagen, cobalt-amine catalysts and the Mn-TACN catalyst. The oxidation catalysts may comprise other metal compounds, such as iron or cobalt complexes.

The skilled person will be aware of other oxidation catalysts that may be successfully combined with the detergent compositions.

The oxidation catalysts may comprised between 0.005 and 1% by weight of the detergent formulation, preferably between 0.05 and 0.5% by weight, most preferably between 0.1 and 0.3% by weight.

Surfactants

The detergent compositions may comprise surfactants. These are usually non-ionic surfactants.

Non-ionic surfactants are preferred for automatic dishwashing (ADW) detergents since they are defined as low foaming surfactants. The standard non-ionic surfactant structure is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO).

The length of the fatty alcohol and the degree of ethoxylation and/or propxylation determines if the surfactant structure has a melting point below room temperature or in other words if is a liquid or a solid at room temperature.

Surfactants may also comprise butylene oxide units (BO) as a result of butoxylation of the fatty alcohol. Preferably, this will be a mix with PO and EO units. The surfactant chain can be terminated with a butyl (Bu) moiety.

Preferred solid non-ionic surfactants are ethoxylated non-ionic surfactants prepared by the reaction of a mono-hydroxy alkanol or alkylphenol with 6 to 20 carbon atoms. Preferably the surfactants have at least 12 moles, particularly preferred at least 16 moles, and still more preferred at least 20 moles, such as at least 25 moles of ethylene oxide per mole of alcohol or alkylphenol.

Particularly preferred solid non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

The non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols which additionally comprise poly-oxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and poly-oxypropylene and block copolymers of polyoxyethylene and polyoxypropylene initiated with trimethylolpropane. Another preferred class of non-ionic surfactant can be described by the formula:

R₁O[CH₂CH(CH₃)O]ₓ[CH₂CH₂O]_{y}[CH₂CH(OH)R₂]

where R₁ represents a linear or branched chain aliphatic hydrocarbon group with 4-18 carbon atoms or mixtures thereof, R₂ represents a linear or branched chain aliphatic hydrocarbon rest with 2-26 carbon atoms or mixtures thereof, x is a value between 0.5 and 1.5 and y is a value of at least 15.

Another group of preferred non-ionic surfactants are the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃=H, methyl or ethyl are particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃=H) or propylene oxide (R₃=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

A particularly preferred liquid non-ionic surfactant has the general formula

R₁-[EO]ₙ-[PO]ₘ-[BO]ₚ-Bu_{q}

wherein:
R₁ is an alkyl group of between C₈ and C₂₀;
EO is ethylene oxide;

PO is propylene oxide;
BO is butylene oxide;
Bu is butylene
n and m are integers from 1 to 15;
p is an integer from 0 to 15; and
q is 0 or 1.

Examples of especially preferred nonionic surfactants are the Plurafac™, Lutensol™ and Pluronic™ range from BASF, Dehypon™ series from Cognis/BASF and Genapol™ series from Clariant.

The total amount of surfactants typically included in the detergent compositions is in amounts of up to 15% by weight, preferably of from 0.5% to 10% by weight and most preferably from 1% to 5% by weight.

Preferably non-ionic surfactants are present in the detergent compositions in an amount of from 0.1% to 10% by weight, more preferably 0.25% to 7% by weight and most preferably 0.5% to 5% by weight.

Bleach Activators

Generally the use of a bleach activator in a detergent composition can lead to a significant reduction in the effective washing temperature. The detergent compositions may also comprise a bleach activator.

If desired therefore, the detergent compositions may comprise one or more additional bleach activators depending upon the nature of the bleaching compound.

Any suitable bleach activator or combination of bleach activators may be included. A non-limiting example of a common bleach activator is tetraacetylethylenediamine (TAED).

Conventional amounts of the bleach activators may be used e.g. in amounts of from 0.5% to 30% by weight, more preferred of from 1% to 25% by weight and most preferred of from 2% to 20% by weight of the detergent composition.

Enzymes

The detergent composition may comprise one or more enzymes. Desirably the enzyme is present in the compositions in an amount of from 0.01% to 5% by weight especially 0.01% to 4% by weight, for each type of enzyme when added as a commercial preparation. As they are not 100% active preparations this represents an equivalent amount of 0.005% to 1% by weight of pure enzyme, preferably 0.01% to 0.75% by weight, especially 0.01% to 0.5% by weight of each enzyme used in the compositions. The total amount of enzyme in the detergent composition is preferably in the range of from 0.01% to 6% weight percent, especially 0.01% to 3% by weight, which represents an equivalent amount of 0.01% to 2% by weight of pure enzyme, preferably 0.02% to 1.5% by weight, especially 0.02% to 1% by weight of the total active enzyme used in the compositions.

Any type of enzyme conventionally used in detergent compositions may be used according to the present invention. It is preferred that the enzyme is selected from proteases, lipases, amylases, cellulases, pectinases, laccases, catalases and all oxidases, with proteases, pectinases and amylases, (especially proteases) being most preferred. It is most preferred that protease and/or pectinases and/or amylase enzymes may be included in the compositions according to the invention; such enzymes are especially effective for example in dishwashing detergent compositions. Any suitable species of these enzymes may be used as desired.

Anti Corrosion Agents

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, Ill, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃. Any suitable source of multivalent ions may be used, with the source preferably being chosen from sulphates, carbonates, acetates, gluconates and metal-protein compounds. Zinc salts are specially preferred glass corrosion inhibitors.

Any conventional amount of the anti-corrosion agents may be included in the compositions of the invention. However, it is preferred that they are present in an total amount of from 0.01% to 5% by weight, preferably 0.05% to 3% by weight, more preferably 0.1% to 2.5% by weight, such as 0.1% to 1% by weight based on the total weight of the composition. If more than one anti-corrosion agent is used, the individual amounts may be within the preceding amounts given but the preferred total amounts still apply.

Format of the Composition

The detergent composition may take any form known in the art. Possible forms include tablets, powders, gels, pastes and liquids. The detergent compositions may also comprise a mixture of two or more forms. For example the composition may comprise a liquid/gel component comprising the PAP suspension and a free powder component.

The detergent compositions may be housed in PVOH rigid capsules or film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The invention is further demonstrated by the following non-limiting examples. Further examples within the scope of the invention will be apparent to the person skilled in the art.

Description of the Mixing of a PAP Suspension

An example, non limiting aqueous PAP suspension of the present invention is composed of:
20-45% PAP powder (60-70% active)
55-70% Sorbitol (70%) solution (sugar)
0-0.5% xanthan gum (thickening agent)
0-10% distilled water

This was prepared by a generally applicable method:
a) The sugar (sorbitol solution) and optional distilled water are mixed and homogenised
b) Optionally, the thickening agent (xanthan gum) is added into mixture of a) and stirred until it is completely dissolved
c) PAP powder is added into mixture of b) and stir until the whole suspension is completely homogenized

Sorbitol is provided as a 70% solution is water. Other sugars may be solids and need water adding.

Storage Stability

The following non-limiting aqueous PAP suspension according to the present invention was prepared according to the method described above.

| Component | Source | % by weight |
|---|---|---|
| Water | — | 10 |
| Xanthan Gum | Rhodopol-23 ® | 0.3 |
| Sorbitol | Sorbitol OX 70 | 69.7 |
| PAP | Eureco WMI ®PAP Powder | 20 |

The aqueous PAP suspension above was then titrated to determine the concentration of active PAP by weight and then tested for storage stability at a range of different storage conditions.

Samples were again titrated at later intervals to determine the remaining active PAP content

The table below outlines the stability results obtained.

| | Week 0 | Week 1 | Week 3 | Week 6 | Week 12 |
|---|---|---|---|---|---|
| −10° C. | 11.40 | 11.30 | 11.15 | 11.29 | 11.30 |
| 25° C./50% | 11.40 | Not tested | 11.30 | 11.37 | 11.17 |
| relative | | | | | |
| humidity | | | | | |
| 30° C./70% | 11.40 | Not tested | 11.28 | 11.19 | 11.08 |
| relative | | | | | |
| humidity | | | | | |
| 40° C. | 11.40 | Not tested | 11.38 | 10.62 | 9.47 |
| 50° C. | 11.40 | 11.60 | 10.96 | Not tested | Not tested |

The results demonstrate that the PAP suspensions of the present invention are stable over 12 weeks storage at room temperatures. Greater than 97% of the active pap remained in the suspension after storage for 12 weeks at 30° C. and 70% relative humidity.

The composition was also stored in PVOH films (PT-90 from Aicello) for 12 weeks and showed no degradation of the film after this time.

1. An aqueous liquid PAP suspension comprising solid PAP dispersed in an aqueous sugar compound.

2. The suspension according to claim 1, wherein the solid PAP comprises between 5 and 45% by weight.

3. The suspension according claim 1, wherein the aqueous sugar compound is 10 sorbitol.

4. The suspension according to claim 1, wherein the aqueous sugar compound comprises between 40 and 70% by weight.

5. The suspension according to claim 1, wherein the suspension is polyvinyl alcohol (PVOH) stable.

6. The suspension according to claim 1 further comprising a thickening agent.

7. The suspension according to claim 6, wherein the thickening agent comprises xanthan gum.

8. The suspension according to claim 1, wherein the suspension comprises:
20-45% by weight PAP powder;
55-70% by weight sorbitol;
0-0.5% by weight xanthan gum; and
0-10% by weight distilled water

9-11. (canceled)

12. An automatic ware washing detergent composition comprising the suspension according to claim 1.

13. The automatic ware washing detergent composition of claim 12 further comprising PVOH at least partially enclosing the composition.

14. The composition of claim 12 that is formulated to be a monodose composition.

15. (canceled)

16. An automatic dishwashing (ADW) detergent formulation comprising the suspension according to claim 1.

17. An aqueous PAP suspension comprising:
solid PAP; and
an aqueous sugar compound;
wherein the solid PAP is dispersed in the aqueous sugar compound; and
wherein the form of the aqueous PAP suspension is selected from the group consisting of liquid and gel.

18. The suspension according to claim 17, wherein the solid PAP comprises between 5 and 45% by weight; and
wherein the aqueous sugar compound comprises between 40 and 70% by weight.

19. The suspension according to claim 17 further comprising xanthan gum.

20. The suspension according to claim 17, wherein the suspension comprises:
20-45% by weight of the solid PAP;
55-70% by weight of the aqueous sugar compound;
0-0.5% by weight of a thickening agent; and
0-10% by weight distilled water.

21. The method of making the aqueous PAP suspension of claim 17 comprising:
mixing the aqueous sugar compound optionally with distilled water;
homogenizing the aqueous sugar compound optionally with distilled water;
optionally adding a thickening agent to the homogenized mixture;
adding solid PAP to the homogenized mixture with optional thickening agent; and
homogenizing the mixture of solid PAP and the homogenized mixture with optional thickening agent.

22. The method of making the aqueous PAP suspension of claim 17 comprising:
mixing the aqueous sugar compound with 0-10% by weight distilled water;
homogenizing the mixed aqueous sugar compound with the 0-10% by weight distilled water;
adding from 0-0.5% by weight of a thickening agent to the homogenized and mixed aqueous sugar compound with the 0-10% by weight distilled water;
adding PAP powder to the mixed 0-0.5% by weight thickening agent and the homogenized and mixed aqueous sugar compound with the 0-10% by weight distilled water; and
homogenizing the mixture of PAP powder, the 0-0.5% by weight thickening agent and the homogenized and mixed aqueous sugar compound with the 0-10% by weight distilled water.

23. The method of claim 22 further comprising:
completely dissolving the aqueous sugar compound with the 0-10% by weight distilled water; and
stirring the homogenized mixture of the PAP powder, the 0-0.5% by weight thickening agent and the homogenized and mixed aqueous sugar compound with the 0-10% by weight distilled water until the suspension is completely homogenized.
c) PAP powder is added into mixture of b) and stir until the whole suspension is completely homogenized

24. The method of claim 22, wherein the aqueous sugar compound comprises sorbitol.

25. The method of claim 22, wherein the thickening agent comprises xanthan gum.
